(19) United States
(12) Patent Application Publication
(10) Pub. No.: US 2016/0238919 A1
(43) Pub. Date: Aug. 18, 2016

(54) IMAGING APPARATUS

(71) Applicant: HOYA CORPORATION, Tokyo (JP)

(72) Inventor: Masashi NAKANO, Tokyo (JP)

(73) Assignee: HOYA CORPORATION, Tokyo (JP)

(21) Appl. No.: 15/015,574

(22) Filed: Feb. 4, 2016

(30) Foreign Application Priority Data
Feb. 12, 2015 (JP) 2015-025452

(51) Int. Cl. G03B 11/04; G03B 17/17

(52) U.S. Cl. CPC G03B 11/045; G03B 17/17

(57) ABSTRACT

An imaging apparatus includes an optical path forming member which includes at least one exterior wall surrounding an imaging optical system and defines an optical path inside the exterior wall; a through-portion which extends through the exterior wall of the optical path forming member; a lid member which covers the through-portion from the outside of the optical path forming member; and a plurality of light shield walls provided on one of the optical path forming member and the lid member, wherein the plurality of light shield walls are intermittently arranged in a direction along an optical axis of the imaging optical system so that the through-portion includes a plurality of internal spaces which are respectively positioned between the light shield walls.

### BACKGROUND OF THE INVENTION

1. Field of the Invention

The present invention relates to an imaging apparatus, and in particular relates to an imaging apparatus equipped with a light shield structure which prevents unwanted light from being incident on an imaging surface.

2. Description of the Related Art

Imaging apparatuses are typically provided with a light shield structure, as needed, for preventing or reducing internal reflection of unwanted light (that does not contribute to image formation on the imaging surface) in an optical path from traveling toward an imaging surface in order to prevent deterioration in the quality of photographing images (e.g., to prevent flare and ghost from occurring). As an example of such a light shield structure, a light shield structure in which saw-tooth light-shield grooves (light-shield lines) are formed on the inner wall surface of a (round, rectangular or square) tubular portion constituting part of a lens barrel is disclosed in Japanese Unexamined Patent Publication No. 2012-226317 (Patent Literature 1). In Japanese Unexamined Patent Publication No. 2007-163637 (Patent Literature 2), a light shield structure is disclosed in which a stray-light reflecting surface having a curved shape, which reflects unwanted light rays among the light rays incident from a diaphragm aperture (opening) back toward the diaphragm aperture to prevent these unwanted light rays from traveling toward the imaging surface, is formed on the inner periphery of a tubular portion of a lens barrel.

To form light-shield grooves such as disclosed in Patent Literature 1 or a stray light reflecting surface such as disclosed in Patent Literature 2, the thickness of the aforementioned tubular portion, which constitutes part of a lens barrel, must be great. However, imaging apparatuses of recent years which are incorporated in cellular phones or smartphones have been miniaturized to a remarkable degree, and the components of these apparatuses are extremely small in size compared with those of conventional imaging apparatuses, (i.e., imaging apparatuses having a camera as its main function) and accordingly, there has been a problem with it being difficult for the tubular portion, which constitutes part of a lens barrel, to secure a sufficient thickness to allow the tubular portion to be provided thereon with known light-shield grooves or with a known stray-light reflecting surface.

### SUMMARY OF THE INVENTION

The present invention has been devised in view of the above described problem, and the present invention provides an imaging apparatus capable of reducing internal reflection of light in an optical path with a space-saving structure.

According to an aspect of the present invention, an imaging apparatus is provided, including an optical path forming member which includes at least one exterior wall surrounding an imaging optical system and defines an optical path inside the exterior wall; a through-portion which extends through the exterior wall of the optical path forming member; a lid member which covers the through-portion from the outside of the optical path forming member; and a plurality of light shield walls provided on one of the optical path forming member and the lid member, wherein the plurality of light shield walls are intermittently arranged in a direction along an optical axis of the imaging optical system so that the through-portion includes a plurality of internal spaces which are respectively positioned between the light shield walls.

It is desirable for the plurality of internal spaces to be a plurality of slits provided in the exterior wall of the optical path forming member, and for the plurality of light shield walls to be portions of the exterior wall, the plurality of light shield walls being alternately positioned between the plurality of slits in the direction along the optical axis of the imaging optical system.

It is desirable for the lid member to include a protrusion which is inserted into the through-portion, and for the plurality of light shield walls to be provided on the protrusion of the lid member.

It is desirable for the imaging optical system to include at least one movable lens group which is movable along the optical axis. A range of formation of the through-portion and the plurality of light shield walls in the direction along the optical axis includes at least a part of a moving range of the movable lens group, the part of the moving range ranging from a center of the moving range to a limit of travel of the movable lens group on the image side of the moving range.

It is desirable for the through-portion and the plurality of light shield walls to be provided on at least a portion of the exterior wall, a distance from the optical axis to the portion of the exterior wall being the shortest compared to distances, in a plane orthogonal to the optical axis, from the optical axis to a remaining portion of the exterior wall.

It is desirable for the optical path forming member to be formed from a combination of a box-shaped body and a cover, wherein one side of sides of the box-shaped body that surround the optical path is open, the cover closes the opening of the box-shaped body, and the through-portion is provided in the cover.

It is desirable for the lid member to include a thin sheet which is smaller in thickness than the exterior wall of the optical path forming member.

It is desirable for the imaging optical system to include a bending optical system, including a reflector element which reflects light rays traveling from an object toward the image plane, and for the through-portion and the plurality of light shield walls to be provided at positions which are closer to the image side than the reflector element and surround the optical path.

In an embodiment, an imaging apparatus is provided, including an optical path forming member which includes at least one exterior wall surrounding an imaging optical system and defines an optical path inside the exterior wall; a plurality of slits which extend through the exterior wall of the optical path forming member and a plurality of light shield walls which are formed as portions of the exterior wall, the plurality of slits and the plurality of light shield walls being provided in the optical path forming member and alternately arranged in a direction along an optical axis of the imaging optical system; and a cover sheet which is mounted onto an outer surface of the exterior wall of the optical path forming member to cover the plurality of slits.

It is desirable for the optical path forming member to be formed from a combination of a box-shaped body and a cover, wherein one side of sides of the box-shaped body that surround the optical path is open, the cover closes the opening of the box-shaped body, and the plurality of slits are provided in the cover.

In an embodiment, an imaging apparatus is provided, including an optical path forming member which includes at least one exterior wall surrounding an imaging optical system and defines an optical path inside the exterior wall; a through-hole which extends through the exterior wall of the optical path forming member; a cover sheet which is mounted onto an outer surface of the exterior wall of the optical path forming member to cover the through-hole, the cover sheet including a protrusion which is inserted into the through-hole; and a plurality of grooves and a plurality of light shield walls which are provided in the protrusion of the cover sheet and alternately arranged in a direction along an optical axis of the imaging optical system.

It is desirable for the optical path forming member to be formed from a combination of a box-shaped body and a cover, wherein one side of sides of the box-shaped body that surround the optical path is open, the cover closes the opening of the box-shaped body, and the through-hole is provided in the cover.

According to the imaging apparatus of the present invention, internal reflection of light in an optical path can be reduced with a space-saving structure with no increase in wall thickness of the optical path forming member.

The present disclosure relates to subject matter contained in Japanese Patent Application No. 2015-25452 (filed on Feb. 12, 2015) which is expressly incorporated herein by reference in its entirety.

### BRIEF DESCRIPTION OF THE DRAWINGS

The present invention will be described below in detail with reference to the accompanying drawings in which:

FIG. 1 is a front external perspective view of an embodiment of an imaging apparatus according to the present invention, viewed from the object side;

FIG. 2 is a rear external perspective view of the imaging apparatus, viewed from the opposite side thereof from the side shown in FIG. 1;

FIG. 3 is a rear external perspective view of the imaging apparatus with the cover sheet shown in FIG. 2 removed;

FIG. 4 is an exploded perspective view of the imaging apparatus, viewed from the opposite side thereof from the object side;

FIG. 5 is a perspective view of an internal structure of the imaging apparatus and a cover member thereof in a state where the second lens group and the third lens group are positioned at their respective positions when the imaging optical system is set at the telephoto extremity, viewed from the object side;

FIG. 6 is a perspective view of an internal structure of the imaging apparatus in a state where the second lens group and the third lens group are positioned at their respective positions when the imaging optical system is set at the wide-angle extremity, viewed from the opposite side of the imaging apparatus from the side shown in FIG. 5;

FIG. 7 is a sectional view of the imaging apparatus, taken along a plane lying on the first, second and third optical axes;

FIG. 8 is a sectional view of part of the imaging apparatus, illustrating a state where internal reflection of light is reduced by a plurality of light shield walls and a light shield frame;

FIG. 9 is a sectional view of part of the imaging apparatus, illustrating a state where internal reflection of light is reduced only by the plurality of light shielding walls;

FIG. 10 is a rear external perspective view of a second embodiment of the imaging apparatus with the cover sheet removed, viewed from the opposite side of the imaging apparatus from the object side;

FIG. 11 is an exploded perspective view of the second embodiment of the imaging apparatus, viewed from the opposite side thereof from the object side;

FIG. 12 is a perspective view of the cover sheet shown in FIG. 11 that constitutes an element of the second embodiment of the imaging apparatus, viewed from the object side; and

FIG. 13 is a sectional view of the cover sheet shown in FIGS. 11 and 12, taken along the line XIII-XIII shown in FIG. 12.

### DESCRIPTION OF THE PREFERRED EMBODIMENTS

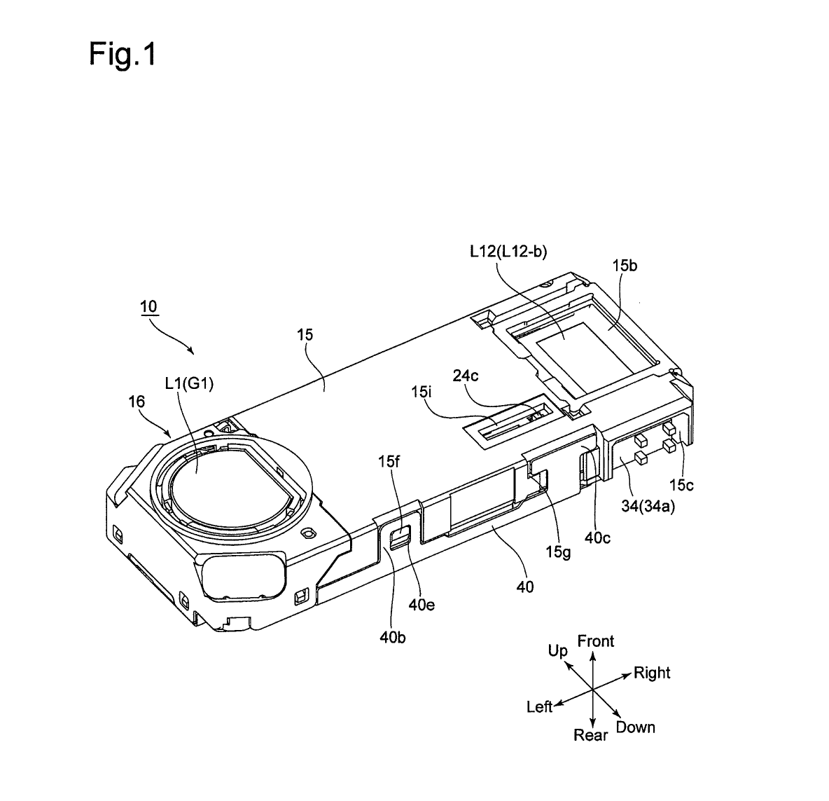

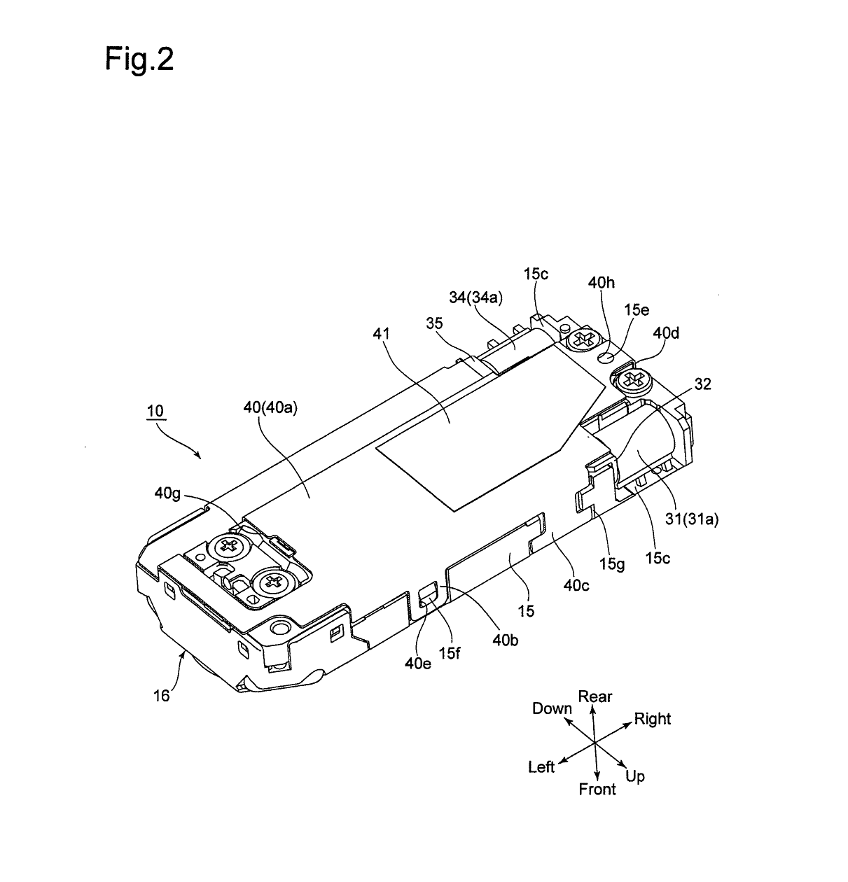

An embodiment of an imaging apparatus (imaging unit) 10 according to the present invention will be discussed below with reference to FIGS. 1 through 9. In the following descriptions, forward and rearward directions, leftward and rightward directions, and upward and downward directions are determined with reference to the directions of the double-headed arrows shown in the drawings. The imaging apparatus 10 has an elongated shape which is thin in the forward and rearward directions and long in the leftward and rightward directions as shown in FIGS. 1 and 2, each showing the external appearance and shape of the imaging apparatus 10. The imaging apparatus 10 can be incorporated in various mobile apparatuses such as a cellular phone, a smart phone and tablet computer.

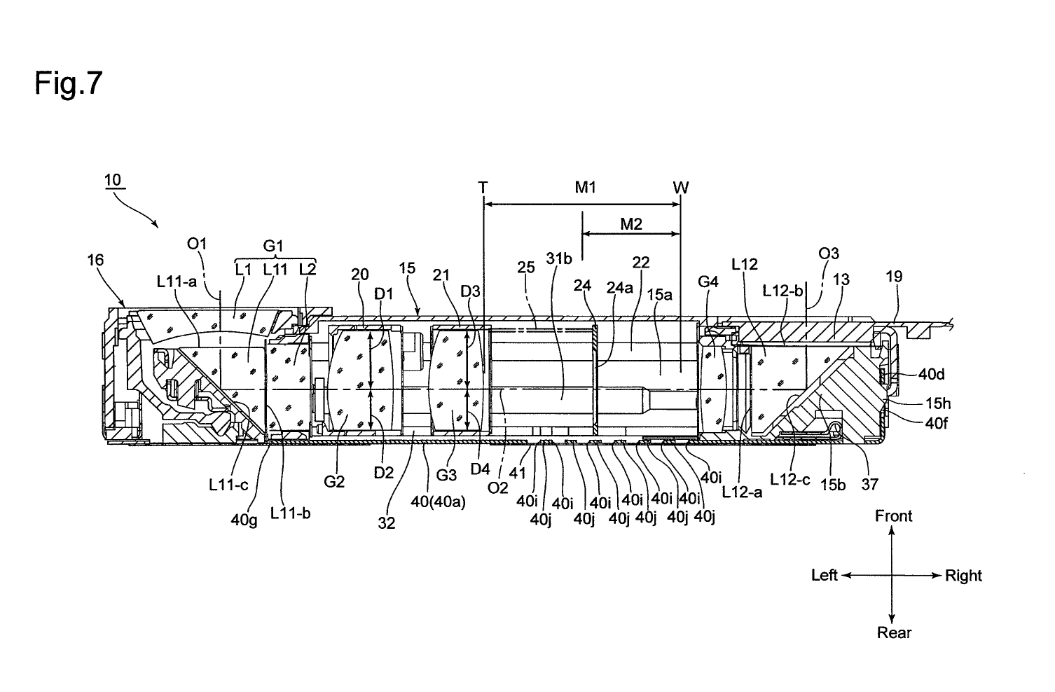

The imaging apparatus 10 is provided with an imaging optical system shown in FIG. 7. As shown in FIG. 7, this imaging optical system is provided with a first lens group G1, a second lens group G2, a third lens group (movable lens group) G3 and a fourth lens group G4, in that order from the object side. The first lens group G1 is provided with a first prism (reflector element) L11, and the imaging apparatus 10 is further provided, on the image plane side of the fourth lens group G4, with a second prism L12. The imaging optical system of the imaging apparatus 10 is configured as a bending optical system which reflects (bends) light rays at substantially right angles at each of the first prism L11 and the second prism L12. The first lens group G1 is configured of a first lens element L1, the first prism L11 and a second lens element L2. The first lens element L1 is positioned in front of (on the object side of) an incident surface L11-a of the first prism L11, while the second lens element L2 is positioned on the right-hand side (image side) of an exit surface L11-b of the first prism L11. Each of the second lens group G2, the third lens group G3 and the fourth lens group G4 is a lens group including no reflector element (prism). The second prism L12 is provided with an incident surface L12-a and an exit surface L12-b, and the incident surface L12-a is positioned on the right-hand side of the fourth lens group G4. The imaging apparatus 10 is provided with an image sensor (image pickup device) 13 in front (on the image side) of the exit surface L12-b of the second prism L12. The image sensor 13 is arranged so that the imaging surface thereof faces the exit surface L12-b of the second prism L12. Although the first lens element L1, the second lens element L2, the second lens group G2, the third lens group G3 and the fourth lens group G4 are each shown as a single lens element in FIG. 7, each of these four optical elements can be composed of a plurality of lens elements.

In the imaging optical system of the imaging apparatus 10, the optical axis before being bent by a reflecting surface L11-c of the first prism L11 (i.e., the optical axis of the first lens element L1) will be hereinafter referred to as the first optical axis O1, the optical axis after being bent by the first prism L11 and extending to a reflecting surface L12-c of the second prism L12 will be hereinafter referred to as the second optical axis O2 (which is coincident with the optical axes of the second lens element L2, the second lens group G2, the third lens group G3 and the fourth lens group G4), and the optical axis after being bent by the reflecting surface L12-c of the second prism L12 will be hereinafter referred to as the third optical axis O3. The first optical axis O1, the second optical axis O2 and the third optical axis O3 define a plane that lies on the sheet of FIG. 7.

Object-emanating light rays that are incident on the first lens element L1, along the first optical axis O1, enter the first prism L11 through the incident surface L11-a and are reflected by the reflection surface L11-c of the first prism L11 in a direction along the second optical axis O2 to exit from the exit surface L11-b of the first prism L11.

Subsequently, the light rays emanating from the exit surface L11-b of the first lens element L11 pass through the second lens element L2 of the first lens group G1 and the second through fourth lens groups G2, G3 and G4, which lie on the second optical axis O2, and are incident on the second prism L12 via the incident surface L12-a thereof. Subsequently, the light rays which are passed through the incident surface L12-a are reflected by the reflection surface L12-c of the second prism L12 in a direction along a third optical axis O3 (extending forwardly) and are incident on the imaging surface of the image sensor 13 to form an object image thereon.

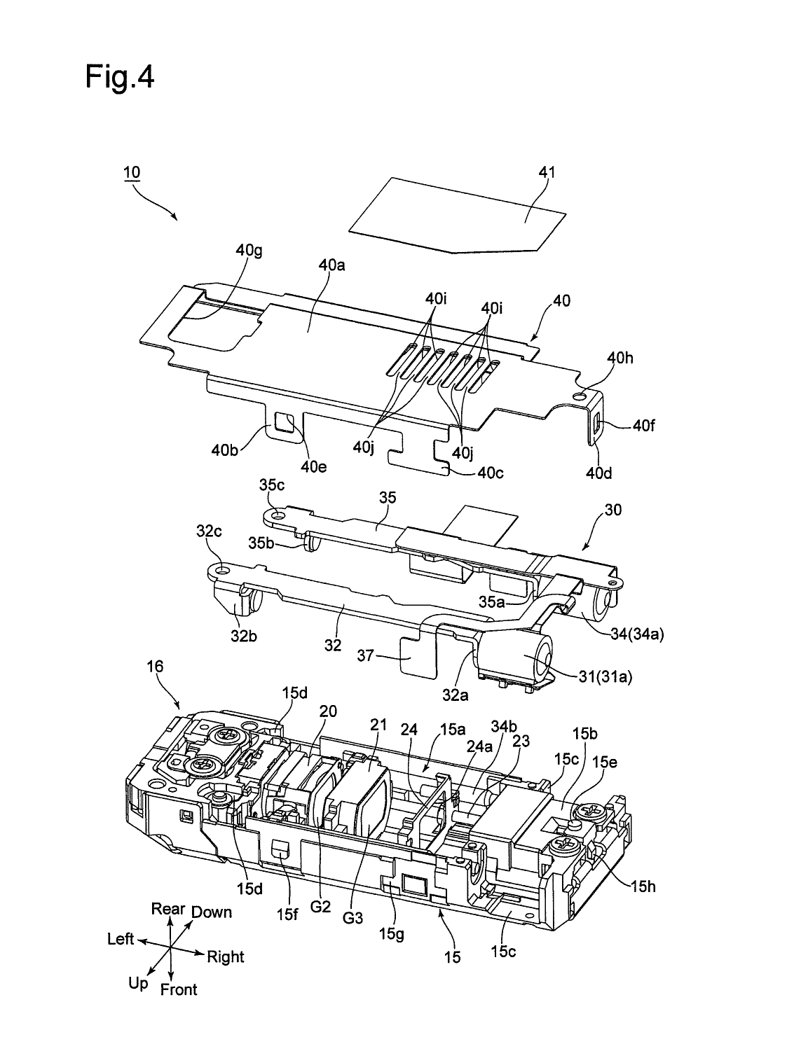

As shown in FIG. 4, the imaging apparatus 10 is provided with a housing (part of an optical path forming member/box-shaped body) 15, a first lens-group unit 16, a motor unit 30, a cover member (part of the optical path forming member/cover) 40 and a cover sheet (lid member/sheet) 41. The housing 15 is a box-shaped body which is elongated in the leftward and rightward directions along the second optical axis O2 and which is small in thickness in the forward and rearward directions along the optical axes O1 and O3. Furthermore, this box-shaped housing 15 is hollow, and a major part of the rear of the hollow body thereof is open. The first lens group G1 and a support mechanism therefor are unitized to be provided as the first lens-group unit 16. The first lens-group unit 16 is mounted to one end (specifically the left end) of the housing 15, with respect to the lengthwise direction thereof. FIG. 4 that shows an exploded perspective view of the imaging apparatus 10 shows a state where the housing 15 and the first lens-group unit 16 are combined. The fourth lens group G4, the second prism L2 and the image sensor 13 (see FIG. 7) are fixedly held by the housing 15 in the vicinity of the other end (specifically the right end) thereof in the lengthwise direction of the housing 15. The image sensor 13 is connected to a drive control circuit, which is provided in a mobile apparatus in which the imaging apparatus 10 is incorporated, via a flexible printed wiring board 19 (see FIG. 7).

As shown in FIGS. 4 and 7, the housing 15 is provided therein with an optical path space 15a in which the second lens group G2 and the third lens group G3 are accommodated. The housing 15 is provided on the right-hand side of the optical path space 15a with a holding frame 15b which fixedly holds the fourth lens group G4 and the second prim L12. The housing 15 is provided on both sides of the holding frame 15b in the upward and downward directions with two motor holding recesses 15c (see FIGS. 1 through 4). The optical path space 15a and each motor holding recess 15c of the housing 15 are open at the back of the housing 15, and the holding frame 15b of the housing 15 is closed at the back of the housing 15. The housing 15 is further provided, on the rear side thereof in a left part of the optical path space 15a, with an upper and lower pair of bracket support portions 15d (see FIG. 4) and is provided, on the rear of the housing 15 on the right side of the holding frame 15b, with a cover support projection 15e (see FIGS. 2 through 4). In addition, the housing 15 is provided, on each side of the optical path space 15a with respect to the upward and downward directions, with a cover engaging projection 15f and a cover engaging recess 15g, respectively (see FIGS. 1 through 4). The housing 15 is also provided on the right end thereof with a cover engaging projection 15h (see FIG. 4). The housing 15 is provided on the front side thereof with a guide groove 15i which is formed as an elongated groove that is elongated in the leftward and rightward directions (see FIG. 1).

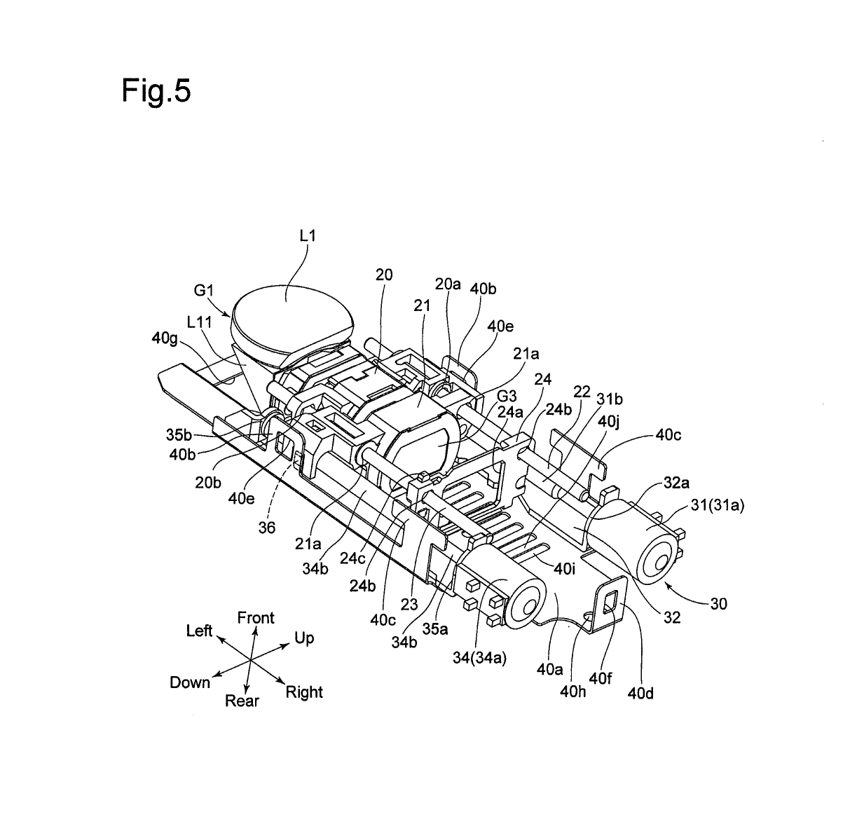

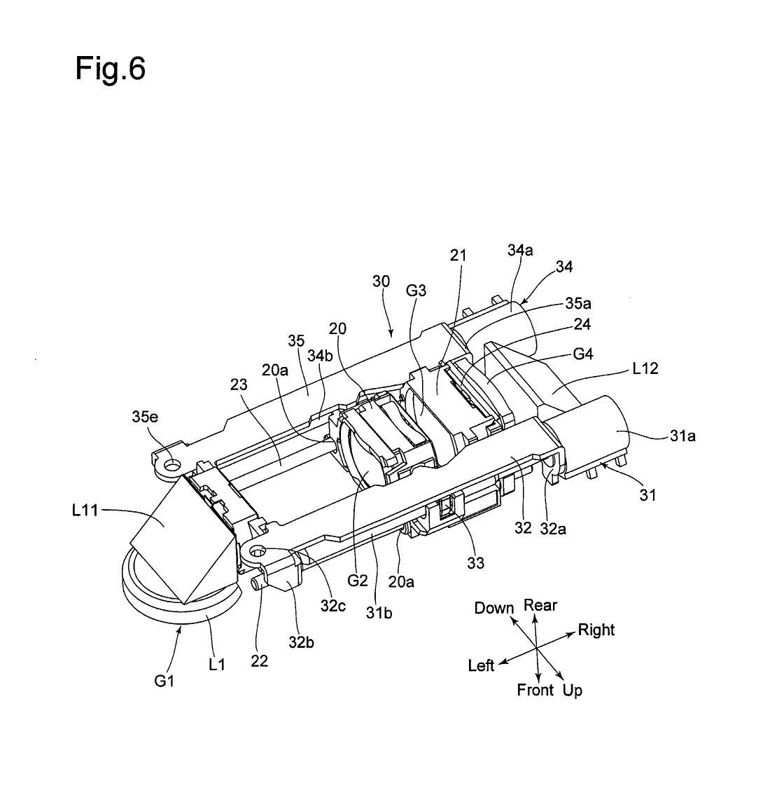

As shown in FIGS. 4 through 6, the imaging apparatus 10 is provided in the optical path space 15a of the housing 15 with an upper and lower pair of guide rods 22 and 23 which extend along both the upper and lower sides of the housing 15. Each guide rod 22 and 23 extends parallel to the second optical axis O2. Both ends (the left and right ends) of each guide rod 22 and 23 are fixed in the housing 15. The second lens group G2 and the third lens group G3 are held by a second lens group frame 20 and a third lens group frame 21, respectively. The second lens group frame 20 is provided with an upper and lower pair of through-holes 20a (see FIG. 6) which are slidably fitted on the pair of guide rods 22 and 23, respectively, and the third lens group frame 21 is provided with an upper and lower pair of through-holes 21a (see FIG. 5) which are slidably fitted on the pair of guide rods 22 and 23, respectively, so that the second lens group frame 20 and the third lens group frame 21 are guided along the second optical axis O2 by the pair of guide rods 22 and 23 to be movable along the second optical axis O2.

As shown in FIGS. 4 through 7, each of the second lens group G2 and the third lens group G4 is non-circular in outer peripheral shape. Specifically, portions of the rim (edge) of each of the second lens group G2 and the third lens group G3 which face the front and the rear of the imaging apparatus 10 are cut off into flat surfaces. The outer peripheral shapes of the second lens element L2 of the first lens group G1 and the lens element which constitutes the fourth lens group G4 are also formed to be non-circular in outer peripheral shape, being similar to those of the second lens group G2 and the third lens group G3. As can be seen from FIG. 7, the formation of each of these lens elements or lens groups (L2, G2, G3 and G4) that are arranged on the second optical axis O2 and have a non-circular shape, so as to reduce the diameter thereof in the forward and rearward directions, makes it possible to reduce the thickness of the imaging apparatus 10 in the forward and rearward directions. Additionally, as shown in FIG. 7, the second lens group G2 is formed so that the distance D2 from the second optical axis O2 to the rear edge (rear flat-cut portion) of the second lens group G2 is smaller than the distance D1 from the second optical axis O2 to the front edge (front flat-cut portion) of the second lens group G2 (i.e., D1>D2); likewise, the third lens group G3 is formed so that the distance D4 from the second optical axis O2 to the rear edge (rear flat-cut portion) of the third lens group G3 is smaller than the distance D3 from the second optical axis O2 to the front edge (front flat-cut portion) of the third lens group G3 (i.e., D3>D4), and accordingly, each of the second lens group G2 and the third lens group G3 is shaped to be asymmetrical about the second optical axis O2 with respect to the forward and rearward directions (with respect to the thickness direction of the imaging apparatus 10). The lens holding portions of the second lens group frame 20 and the third lens group frame 21 are non-circular in shape to correspond to the outer peripheral shapes of the second lens group G2 and the third lens group G3.

As shown in FIGS. 4 through 7, the imaging apparatus 10 is provided between the third lens group G3 (the third lens group frame 21) and the fourth lens group G4 with a light shield frame 24. A central through-hole 24a, having a substantially rectangular shape, is formed at a center of the light shield frame 24, and a front and rear pair of rod insertion holes 24b (see FIG. 5) are formed in the light shield frame 24 at positions above and below the central through-hole 24a. The light shield frame 24 is supported and guided by the upper and lower pair of guide rods 22 and 23 to be slidable thereon along the second optical axis O2 with the front and rear pair of rod insertion holes 24b fitted on the upper and lower pair of guide rods 22 and 23, respectively. The imaging apparatus 10 is provided between the light shield frame 24 and the third lens group frame 21 with an extension spring 25 (conceptually shown by two-dot chain lines in FIG. 7), the axis of which extends in the leftward and rightward directions and one and the other ends of which are hooked onto the light shield frame 24 and the third lens group frame 21, respectively. When no force other than the biasing force of the extension spring 25 is exerted on the light shield frame 24 and the third lens group frame 21, the light shield frame 24 and the third lens group frame 21 are positioned close to each other as shown in FIG. 6. As shown in FIGS. 1 and 5, the light shield frame 24 is further provided with a stopper 24c which projects forwardly to be slidably engaged in a guide slot 15i formed in the housing 15.

As shown in FIGS. 4 through 6, the motor unit 30 is provided with a second-lens-group drive motor 31, a second-lens-group drive motor support bracket 32, a nut 33, a third-lens-group drive motor 34, a third-lens-group drive motor support bracket 35 and a nut 36. The second-lens-group drive motor 31 is configured of a motor body 31a and a lead screw 31b and the third-lens-group drive motor 34 is configured of a motor body 34a and a lead screw 34b. The lead screw 31b projects leftward from the motor body 31a and is rotatable about the axis thereof that is parallel to the second optical axis O2. Likewise, the lead screw 34b projects leftward from the motor body 34a and is rotatable about the axis thereof that is parallel to the second optical axis O2. FIG. 4 shows a state where the lead screw 31b and the lead screw 34b are separated from the second-lens-group drive motor 31 and the third-lens-group drive motor 34, respectively, and positioned in the housing 15 for the purpose of illustration. The female screw hole formed through the nut 33 (see FIG. 6) is screw-engaged with the lead screw 31b of the second-lens-group drive motor 31, and the female screw hole formed through the nut 36 (see FIG. 5) is screw-engaged with the lead screw 34b of the third-lens-group drive motor 34. Each of the nuts 33 and 36 is prevented from rotating about the axis of the associated lead screw 31b or 34b by engagement with a rotation prevention portion (not shown) formed in the housing 15.

As shown in FIGS. 4 through 6, each of the second-lens-group drive motor support bracket 32 and the third-lens-group drive motor support bracket 35 is generally in the shape of a plate extending in the leftward and rightward directions. The second-lens-group drive motor support bracket 32 is provided with a motor-body support lug 32a, a screw support lug 32b and an engaging hole 32c. The motor-body support lug 32a is formed at one end (the right end) of the second-lens-group drive motor support bracket 32 to support the motor body 31a of the second-lens-group drive motor 31, and the screw support lug 32b is formed in the vicinity of the other end (the left end) of the second-lens-group drive motor support bracket 32 to support the end of the lead screw 31b. The engaging hole 32c is formed in the vicinity of the screw support lug 32b to extend through the second-lens-group drive motor support bracket 32 in the forward and rearward directions. Similar to the second-lens-group drive motor support bracket 32, the third-lens-group drive motor support bracket 35 is provided with a motor-body support lug 35a, a screw support lug 35b and an engaging hole 35c. The motor-body support lug 35a is formed at one end (the right end) of the third-lens-group drive motor support bracket 35 to support the motor body 34a of the third-lens-group drive motor 34, and the screw support lug 35b is formed in the vicinity of the other end (the left end) of the third-lens-group drive motor support bracket 35 to support the end of the lead screw 34b. The engaging hole 35c is formed in the vicinity of the screw support lug 35b to extend through the third-lens-group drive motor support bracket 35 in the forward and rearward directions.

The motor unit 30 is installed in the housing 15 with the motor body 31a of the second-lens-group drive motor 31 and the motor body 34a of the third-lens-group drive motor 34 housed in the two (upper and lower) motor holding recesses 15c, respectively, and while portions of the second-lens-group drive motor support bracket 32 and the third-lens-group drive motor support bracket 35, in the vicinity of the ends (the left ends) thereof, are fitted to the upper and lower pair of bracket support portions 15d to be supported thereby, respectively. Thereupon, the positions of the second-lens-group drive motor support bracket 32 and the third-lens-group drive motor support bracket 35 with respect to the housing 15 are fixed by engaging the engaging holes 32c and 35c with protrusions which protrude from the upper and lower pair of bracket support portions 15d, respectively. The nut 33 is screw-engaged with the lead screw 31b of the second-lens-group drive motor 31 and is also engaged in a nut-engaging recess formed in the second lens group frame 20 (see FIG. 6). The nut 36 is screw-engaged with the lead screw 34b of the third-lens-group drive motor 34 and is also engaged in a nut-engaging recess formed in the third lens group frame 21 (see FIG. 5). Therefore, a combination of the nut 33 and the second lens group frame 20 can integrally move in a direction along the second optical axis O2, and a combination of the nut 36 and the third lens group frame 21 can integrally move in a direction along the second optical axis O2.

The cover member 40 is a press-molded product made of a metal plate and is provided with a planar main body portion (exterior wall) 40a, an upper and lower pair of first engaging lugs 40b, an upper and lower pair of second engaging lugs 40c, and a third engaging lug 40d, as shown in FIGS. 1 through 5. The planar main body portion 40a covers a rear surface of the imaging apparatus 10. The first engaging lugs 40b, the second engaging lugs 40c and the third engaging lug 40d project forward from a peripheral edge of the planar main body portion 40a. The planar main body portion 40a is elongated in a direction of the second optical axis O2. One of the first engaging lugs 40b and one of the second engaging lugs 40c are provided on an upper long edge of the planar main body portion 40a at different positions in the lengthwise direction thereof, and the other first engaging lug 40b and the other second engaging lug 40c are provided on a lower long edge of the planar main body portion 40a at different positions in the lengthwise direction thereof. The third engaging lug 40d is provided on the planar main body portion 40a at one end (the right end) thereof in the lengthwise direction of the planar main body portion 40a. The pair of first engaging lugs 40b are each provided with a rectangular engaging hole 40e, and the third engaging lug 40d is provided with a rectangular engaging hole 40f. The planar main body portion 40a is further provided in the vicinity of the left end thereof with a first lens-group unit exposing hole 40g, through which the first lens-group unit 16 is rearwardly exposed. The planar main body portion 40a is provided in the vicinity of the right end thereof with a circular engaging hole 40h.

The cover member 40 is mounted onto the housing 15, to which all the built-in components such as the motor unit 30 have been fixed and which has been connected to the first lens-group unit 16. More specifically, the cover member 40 is fixedly mounted onto the housing 15 by placing the planar main body portion 40a on the rear of the optical path space 15a, engaging the engaging holes 40e of the upper and lower first engaging lugs 40b with the upper and lower cover engaging projections 15f, engaging the upper and lower second engaging lugs 40c with the upper and lower cover engaging recesses 15g, engaging the engaging hole 40f of the third engaging lug 40d with the cover locking cover 15h, and engaging the circular engaging hole 40h with the cover support projection 15e. Upon the cover member 40 being mounted onto the housing 15, the second-lens-group drive motor support bracket 32 and the third-lens-group drive motor support bracket 35 are pressed by the planar main body portion 40a of the cover member 40, so that the motor unit 30 is stably held inside the housing 15. Some of the components of the first lens-group unit 16 can be installed in and removed from the housing 15 through the first lens-group unit exposing hole 40g with the cover member 40 mounted to the housing 15.

Drive control for the second-lens-group drive motor 31 and the third-lens-group drive motor 34 becomes possible by connecting a flexible printed wiring board 37 (see FIG. 4) which extends from the motor unit 30 to the aforementioned drive control circuit of the mobile apparatus in which the imaging apparatus 10 is incorporated. Driving the second-lens-group drive motor 31 to rotate the lead screw 31b thereof causes the nut 33 to move in the axial direction of the lead screw 31b, thus causing the driving force of the second-lens-group drive motor 31 to be transmitted to the second lens group frame 20 via the nut 33, so that the second lens group frame 20, which is guided by the pair of guide rods 22 and 23, moves along the second optical axis O2. Likewise, driving the third-lens-group drive motor 34 to rotate the lead screw 34b thereof causes the nut 36 to move in the axial direction of the lead screw 34b, thus causing the driving force of the third-lens-group drive motor 34 to be transmitted to the third lens group frame 21 via the nut 33, so that the third lens group frame 21, which is guided by the pair of guide rods 22 and 23, moves along the second optical axis O2.

A power-varying operation (zooming operation) to vary the focal length of the imaging optical system and a focusing operation to bring an object into focus are performed by changing the positions of the second lens group G2 and/or the third lens group G3 in the direction of the second optical axis O2 by moving the second lens group frame 20 and the third lens group frame 21. The third lens group G3 solely moves in the focusing operation, while the second lens group G2 and the third lens group G3 move relative to each other in a predetermined moving manner in the zooming operation. FIGS. 4, 5 and 7 show the positions of the second lens group G2 (the second lens group frame 20) and the third lens group G3 (the third lens group frame 21) when the focal length of the imaging optical system is at a maximum in the zoom range, i.e., when the imaging optical system is set at the telephoto extremity, and FIG. 6 shows the positions of the second lens group G2 (the second lens group frame 20) and the third lens group G3 (the third lens group frame 21) when the focal length of the imaging optical system is at a minimum in the zoom range, i.e., when the imaging optical system is set at the wide-angle extremity.

When the imaging optical system is at the wide-angle extremity as shown in FIG. 6, the third lens group G3 (the third lens group frame 21) is positioned close to the fourth lens group G4, and the second lens group G2 (the second lens group frame 20) is positioned close to the third lens group G3 (the third lens group frame 21) while being positioned at a relatively large distance from the first lens group G1 (from the second lens element L2). In this state, the light shield frame 24 is positioned close to the third lens group frame 21 due to the biasing force of the extension spring 25, while the stopper 24c that is shown in FIG. 1 is positioned in the guide hole 15i at, or in the close vicinity of, the right end thereof.

When the imaging optical system is at the telephoto extremity as shown in FIGS. 4, 5 and 7, the second lens group G2 (the second lens group frame 20) is positioned close to the first lens group G1 (to the second lens element L2), while the third lens group G3 (the third lens group frame 21) is positioned close to the second lens group G2 (the second lens group frame 20) while being positioned at a relatively large distance from the fourth lens group G4. In this state, the light shield frame 24 is in contact with the left end of the guide hole 15i, thus being prevented from further moving leftward, and is positioned in between the third lens group G3 and the fourth lens group G4 in a direction along the second optical axis O2 as shown in FIG. 7. The position of the light shield frame 24 when the imaging optical system is at the telephoto extremity is maintained by the biasing force of the extension spring 25.

If the imaging apparatus 10 having the above described structure is directed at an object located in front thereof, object-emanating light rays that travel through the first lens group G1, the second lens group G2, the third lens group G3, the central through-hole 24a of the light shield frame 24 and the fourth lens group G4 are captured (received) by the imaging surface of the image sensor 13.

FIG. 7 shows the operating range (moving range) M1 of the third lens group G3 in the zoom range from the wide-angle extremity to the telephoto extremity. The moving range of the third lens group G3 when a focusing operation is performed is also included within the operating range M1 shown in FIG. 7. The operating range M1 in FIG. 7 is shown with the position of the surface of the third lens group G3 (the right surface of the third lens group G3 with respect to FIG. 7) which is the closest to the image side as a reference; the position of this surface of the third lens group G3 when the imaging optical system is at the wide-angle extremity is shown by “W” and the position of the same when the imaging optical system is at the telephoto extremity is shown by “T”. When the imaging optical system is at the wide-angle extremity, the distance between the third lens group G3 and the fourth lens group G4 is small, while the light shield frame 24 is positioned close to the third lens group G3, so that the possibility of object-emanating light rays passing through the third lens group G3 (after passing through the first lens group G1 and the second lens group G2) becoming harmful stray light that travels toward the fourth lens group G4, as a result of being reflected by an inner surface of the housing 15 or an inner surface of the cover member 40, is low.

On the other hand, when the imaging optical system is at the telephoto extremity, the distance between the third lens group G3 and the fourth lens group G4 is great, so that the object-emanating light rays are susceptible to being internally reflected by an inner surface of the housing 15 or by an inner surface of the cover member 40 between the third lens group G3 and the fourth lens group G4. The light shield frame 24, which is installed between the third lens group G3 and the fourth lens group G4, has a light shielding function; specifically, the light shield frame 24 can prevent light that is internally reflected in the light path space 15a from traveling toward the fourth lens group G4. However, the imaging apparatus 10 is originally flat in shape and small in thickness in the forward and rearward directions; moreover, the planar main body portion 40a of the cover member 40 is positioned close to the second optical axis O2, according to the above described arrangement in which each of the second lens group G2 and the third lens group G3 is shaped to be asymmetrical about the second optical axis O2 with respect to the forward and rearward directions (D1>D2 and D3>D4 (see FIG. 7)). In other words, the imaging apparatus 10 has four exterior walls (a front wall, an upper wall and a lower wall formed by the housing 15; and a rear wall formed by the planar main body portion 40a of the cover member 40) which surround the second optical axis O2, and the rear wall (the planar main body portion 40a) is closest to the second optical axis O2 among the four exterior walls in a plane orthogonal to the second optical axis O2. Hence, this arrangement of the imaging apparatus 10 makes it susceptible to internal reflection of object-emanating light rays at the cover member 40 (i.e., rear wall). In addition, since the light shield frame 24 is movable along the pair of guide rods 22 and 23, it is required to secure a clearance between the light shield frame 24 and the inner surface of the housing 15 or the cover member 40 to prevent the light shield frame 24 from interfering with the housing 15 or the cover member 40; however, such a clearance forms an unwanted light path through which light travels toward an inner surface of the housing 15 or the cover member 40 after traveling past the outer periphery of the light shield frame 24. Accordingly, to obtain a higher light shielding capability in the imaging apparatus 10 under such conditions, a light shield structure which reduces the internal reflection (namely, a light shield structure which restricts the traveling of the internally reflected light in a direction toward the fourth lens group G4) is provided on the cover member 40 itself, which is a part of the exterior walls forming an optical path of the imaging apparatus 10. This light shield structure will be hereinafter discussed.

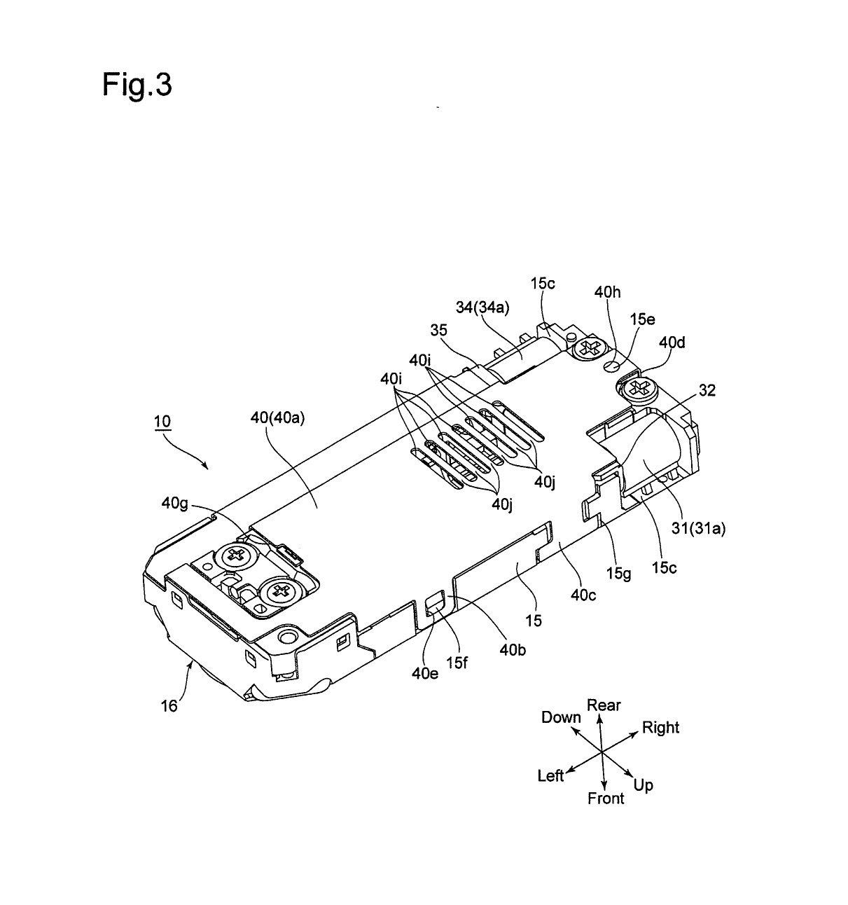

As shown in FIGS. 3 through 5 and 7 through 9, the planar main body portion 40a of the cover member 40 is provided with a plurality of slits (through-portions/internal spaces) 40i, via which the optical path space 15a is communicatively connected with the outside of the imaging apparatus 10. The plurality of slits 40i are elongated through-holes which are parallel to one another, are mutually separated by a predetermined interval (distance), and extend in the vertical direction (the upward and downward directions) of the imaging apparatus 10 (i.e., in a direction substantially orthogonal to the direction of the second optical axis O2). The planar main body portion 40a of the cover member 40 is also provided with a plurality of light shield walls 40j, which are respectively defined between the plurality of slits 40i, so that the plurality of slits 40i and the plurality of light shield walls 40j are alternately arranged. The intervals between the plurality of slits 40i and the intervals between the plurality of light shield walls 40j are substantially identical with respect to a direction along the second optical axis O2, and each slit 40i and each light shield wall 40j are substantially identical in width. As shown in FIG. 7, in a direction along the second optical axis O2, the range of formation of the plurality of slits 40i and the plurality of light shield walls 40j occupies a major part of the operating range M1 of the third lens group G3. In other words, in a direction along the second optical axis O2, the range of formation of the plurality of slits 40i and the plurality of light shield walls 40j is set to correspond to the distance between the third lens group G3 and the fourth lens group G4 when the distance therebetween becomes maximum (i.e., when the imaging optical system is set to the telephoto extremity).

As shown in FIGS. 2, 4 and 7 through 9, the cover sheet (lid member/sheet) 41 is fixed to a rear surface of the planar main body portion 40a of the cover member 40 and externally covers the plurality of slits 40i. The cover sheet 41 is smaller in thickness than the cover member 40. The sheet 41 can be fixed to the cover member 40 by an arbitrary means, for instance, by an adhesive layer formed on one side (front side) of the cover sheet 41 to allow the sheet 41 to be fixed to the cover member 40 via this adhesive layer. In this case, it is desirable for the adhesive layer to provide adhesion to the peripheral area of the sheet 41 that is not directly overlaid on the slits 40i without providing adhesion to a plurality of areas of the cover sheet 41 that are respectively overlaid on the plurality of slits 40i. This makes it possible to reduce the amount of dirt and dust on the cover sheet 41 in the aforementioned plurality of areas that are respectively overlaid on the plurality of slits 40i.

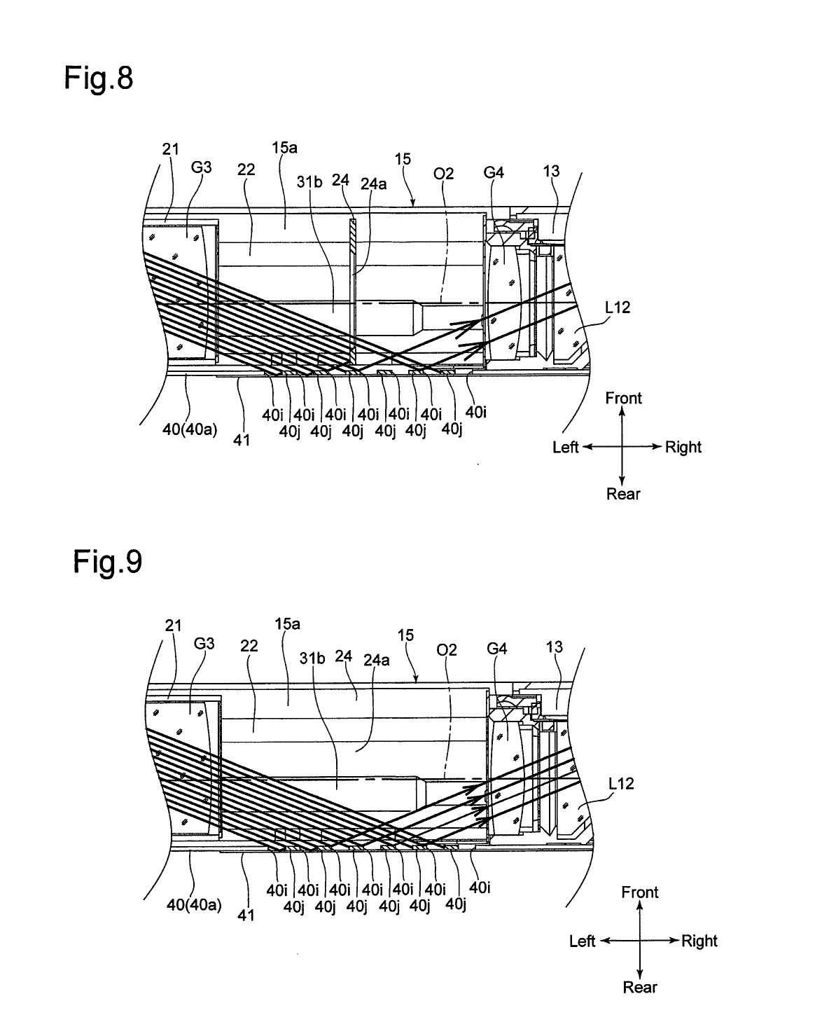

Accordingly, the imaging apparatus 10 incorporates the light shield structure in which a plurality of groove-shaped spaces (the internal spaces of the plurality of through-portions that extend through the planar main body portion 40a), which are formed by the plurality of slits 40i and the cover sheet 41, and the plurality of light shield walls 40j, which are formed as portions of the cover member 40, are alternately arranged. FIGS. 8 and 9 show the function of the light shield structure of the imaging apparatus 10. FIG. 8 shows the case where the light shield structure, which is composed of the cover member 40 and the cover sheet 41, and the light shield frame 24 are both used. FIG. 9 shows the case where only the light shield structure, which is composed of the cover member 40 and the cover sheet 41, is used with the light shield frame 24 removed. As shown in FIGS. 8 and 9, if part of the light rays emanating from the object and passing through the third lens group G3 (after passing through the first lens group G1 and the second lens group G2) travels toward the cover member 40, the light rays which reach the cover sheet 41 and are reflected thereby are prevented from traveling toward the fourth lens group G4 by the sides of the plurality of light shield walls 40j (i.e., by inner side walls of the plurality of slits 40i) at the areas where the plurality of slits 40i are formed. In addition, part of the light traveling toward the cover member 40 directly reaches sides of the plurality of light shield walls 40j before being reflected by the cover sheet 41, thus being prevented from traveling toward the fourth lens group G4.

Namely, the plurality of slits 40i covered by the cover sheet 41 and the plurality of light shield walls 40j that are respectively adjacent to the plurality of slits 40i form a toothed structure having alternate projections and depressions (light-shield grooves) which reduces internal reflection of light caused by the cover member 40. Although there is a possibility of reflection of light which travels toward the fourth lens group G4 occurring at the front surface of each light shield wall 40j that faces toward the second optical axis O2, the total area of the front surfaces of the plurality of light shield walls 40j which are exposed in the optical path space 15a has been reduced by an amount corresponding to the area of formation of the plurality of slits 40i, which makes it possible to minimize the occurrence of harmful stray light. As can be seen from a comparison between FIG. 8 and FIG. 9, a superior light shield effect can be achieved by using the light shield structure, which is composed of the cover member 40 and the cover sheet 41, together with the light shield frame 24 (see FIG. 8); however, a certain degree of light shield effect can be achieved by using only the light shield structure, which is composed of the cover member 40 and the cover sheet 41 (see FIG. 9). Accordingly, the structure of the imaging apparatus 10 from which the light shield frame 24 is omitted is also possible.

The above described light shield structure is configured so that the plurality of slits 40i and the plurality of light shield walls 40j are formed only within the thickness of the planar main body portion 40a in the cover member 40 and not so that a light shield projection is projected inside the optical path space 15a from the cover member 40 or bottomed grooves (serrated teeth, etc.) are formed on the inner surface of the cover member 40; hence, it is possible to minimize the thickness of the cover member 40 (to prevent variations in thickness of the cover member 40). A certain degree of effect can also be achieved by forming only the plurality of slits 40i in the cover member 40 (i.e., without providing the cover sheet 41) in the case where attention is directed only toward suppression of internal reflection; however, when the imaging apparatus 10 is actually constructed, it is required to prevent foreign particles (e.g., dust) from entering the optical path space 15a through the plurality of slits 40i from outside and also to prevent harmful light from entering the optical path space 15a from outside through the plurality of slits 40i. Such harmful external effects can be prevented by providing the cover sheet 41 that covers the plurality of slits 40i. The cover member 40 is a relatively large member which forms an optical path of the imaging apparatus 10 in cooperation with the housing 15, and additionally, the cover member 40 also holds the motor unit 30. Therefore, the cover member 40 is required to have a certain amount of thickness to secure a sufficient strength. Whereas, the cover sheet 41, which is specialized for the purpose of covering the plurality of slits 40i, can be made extremely thin, and accordingly, the additional (minimal) thickness of the cover sheet 41 to the thickness of the cover member 40 hardly exerts an influence on the size of the imaging apparatus 10 in the forward and rearward directions (i.e., the thickness of the imaging apparatus 10), which makes it possible to achieve a superior light shield structure without loss of compactness of the imaging apparatus 10. In a mobile apparatus incorporating the imaging apparatus 10, the plurality of slits 40i need to be covered at least in a state where the imaging apparatus 10 is workable as a component of camera. Accordingly, a wall surface of the mobile apparatus incorporating the imaging apparatus 10 can also be used as a lid member for covering the plurality of slits 40i instead of the cover sheet 41.

The light shield structure of the imaging apparatus 10 is superior also in productivity. Namely, it is difficult to form complicated tooth-shaped light-shield grooves or a light-shielding curved surface on the metal cover member 40 at low production cost, whereas the light shield structure of the imaging apparatus 10 can be achieved simply and at low cost by a simple punch press operation, or the like, because the plurality of slits 40i are simple through-holes formed through the cover member 40. Additionally, the light shield structure is completed simply by mounting the cover sheet 41 to the rear surface of the cover member 40 that includes the plurality of slits 40i and the plurality of light shield walls 40j, which contributes to a reduction in number of man-hours at the time of manufacturing.

The cover sheet 41 can be made of various materials. For instance, the cover sheet 41 can be made of a synthetic resin and formed into a thin film. In addition, to reduce internal reflection, the cover sheet 41 itself can be made low in optical reflectance. Specifically, the optical reflectance can be minimized by, e.g., a technique for making the color of the cover sheet 41 dark (black) or a technique for making the front surface of the cover sheet 41 which faces the plurality of slits 40i a coarse surface or a non-glossy matt surface.

As described above, in the imaging apparatus 10, the plurality of slits 40i and the plurality of light shield walls 40j are formed to correspond to a major portion of the operating range M1 of the third lens group G3 in a direction along the second optical axis O2 (see FIG. 7). With this structure, the effect of reducing internal reflection almost over the entire range between the third lens group G3 and the fourth lens group G4 is obtained; however, it is possible to change the range of formation of the plurality of slits 40i and the plurality of light shield walls 40j. In this case, as a condition for the range of formation of the plurality of slits 40i and the plurality of light shield walls 40j, it is desirable that this range covers at least a rear half range M2 (see FIG. 7) which ranges from the center of the operating range M1 to the limit of travel of the third lens group G3 on the image plane side in the operating range M1 (i.e., to the position of the third lens group G3 when the imaging apparatus is set at the wide-angle extremity).

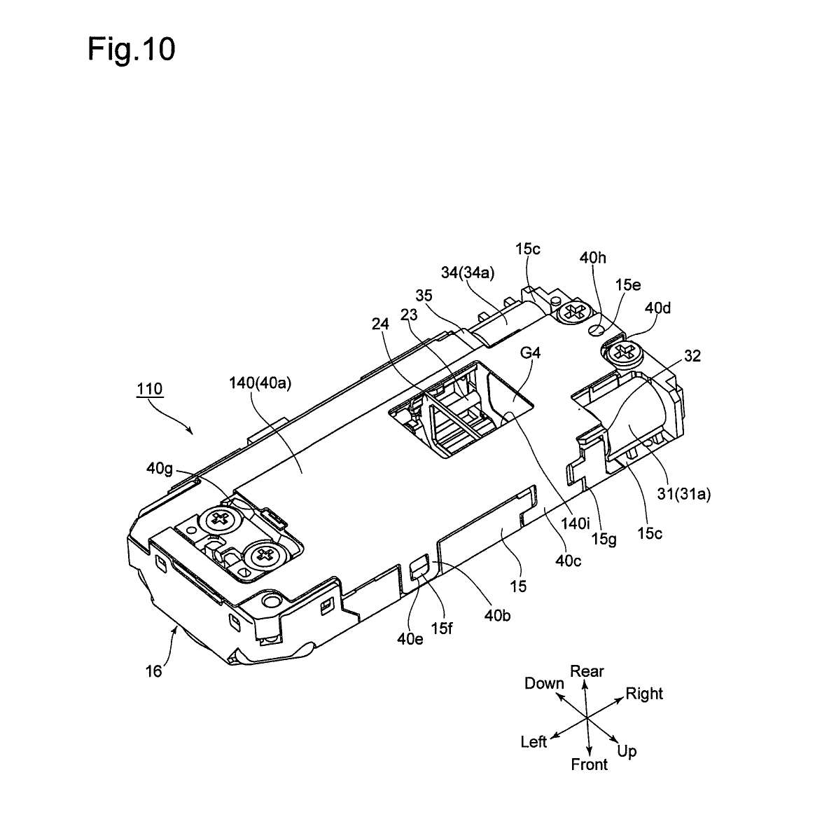

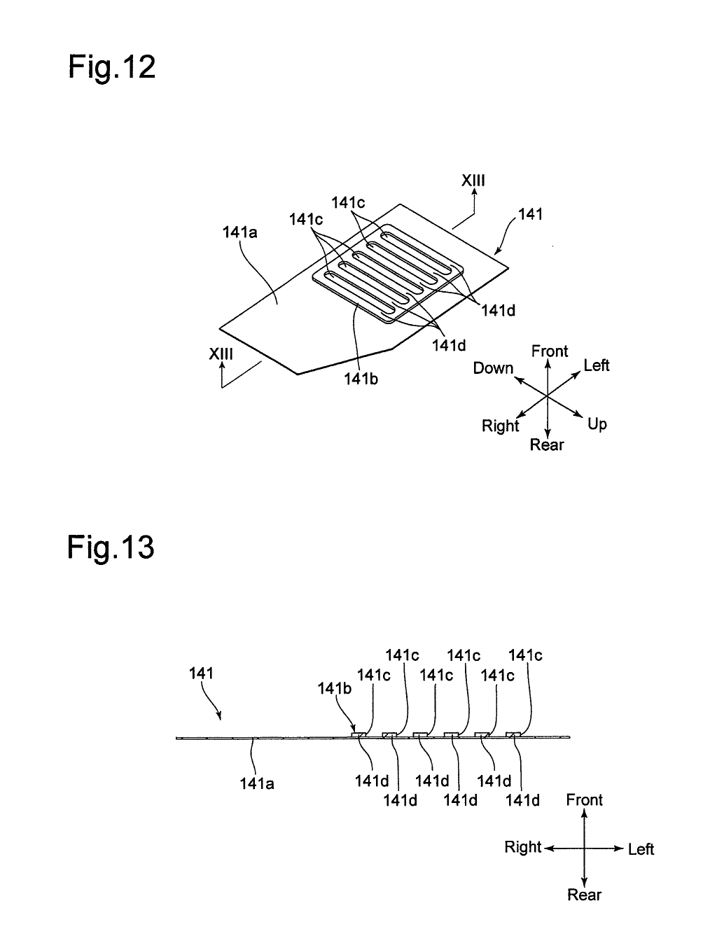

Subsequently, the second embodiment of the imaging apparatus, which is designated by the reference numeral 110, will be hereinafter discussed with reference to FIGS. 10 through 13. In the drawings from FIG. 10 onward, elements and portions of the imaging apparatus 110 which are the same as those of the previous embodiment of the imaging apparatus 10 are designated by the same reference numerals. Specifically, in the imaging apparatus 110, the housing 15 (which contains internal parts such as the second lens group frame 20 and the third lens group frame 21), the first lens-group unit 16 and the motor unit 30 are the same as those of the previous embodiment of the imaging apparatus 10, whereas a cover member (an element of the optical-path forming member/cover) 140 and a cover sheet (lid member/sheet) 141 which are elements of the imaging apparatus 110 and respectively correspond to the cover member 40 and the cover sheet 41 have structures unique to the second embodiment of the imaging apparatus 110.

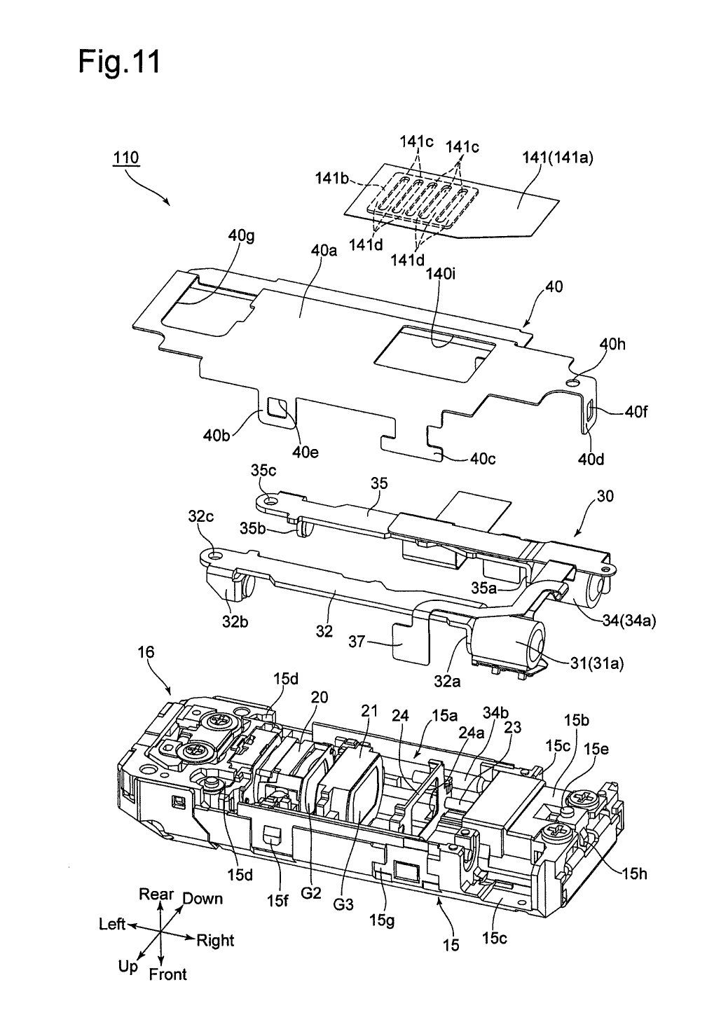

As shown in FIGS. 10 and 11, the planar main body portion 40a of the cover member 140 is provided with a single rectangular through-hole (through-portion) 140i that is formed through the planar main body portion 40a. The size of the rectangular through-hole 140i on the planar main body portion 40a is substantially the same as the total area of the plurality of slits 40i and the plurality of light shield walls 40j, and also the position of formation of the through-hole 140i corresponds to the total area of the plurality of slits 40i and the plurality of light shield walls 40j.

As shown in FIG. 11 through 13, the cover sheet 141 is provided with a sheet body 141a which has a sufficient area for covering the through-hole 140i of the cover member 140 and is further provided on the front side of the sheet body 141a with a protrusion 141b. In FIG. 11, the protrusion 141b, which is provided on the back of the sheet body 141a, is shown by broken lines. In the making of the cover sheet 141, the sheet body 141a and the protrusion 141b can be formed integral with each other, or the protrusion 141b can be fixed onto the sheet body 141a with an adhesive, etc., after the sheet body 141a and the protrusion 141b are formed separately from each other. The cover sheet 141 is provided on the protrusion 141b with a plurality of elongated bottomed grooves (internal spaces) 141c and a plurality of light shield walls 141d which are alternately arranged. The intervals between the plurality of elongated bottomed grooves 141c and the intervals between the plurality of light shield walls 140d are substantially identical, and each elongated bottomed groove 141c and each light shield wall 140d are substantially identical in width.

The cover sheet 141 can be mounted to the cover member 140 by inserting the protrusion 141b into the through-hole 140i and affixing the sheet body 141a to the back of the planar main body portion 40a. The outward appearance of the imaging apparatus 110 with the cover sheet 141 affixed to the planar main body portion 40a is substantially the same as that of the previous embodiment of the imaging apparatus 10 that is shown in FIG. 2, and the through-hole 140i of the cover member 140 is covered by the cover sheet 141. Accordingly, the cover sheet 141 prevents foreign particles from entering the imaging apparatus 110 through the through-hole 140i and prevents harmful light from entering the imaging apparatus 110 from outside through the through-hole 140i.

In a state where the cover sheet 141 is mounted to the cover member 140, both the lengthwise direction of each elongated bottomed grooves 141c and the lengthwise direction of each light shield wall 141d are coincident with the upward/downward direction of the imaging apparatus 110 (i.e., a direction substantially orthogonal to the direction of the second optical axis O2 that is shown in FIG. 7), and the plurality of elongated bottomed grooves 141c and the plurality of light shield walls 141d are alternately arranged in a direction along the second optical axis O2. The protruding amount of the protrusion 141b of the cover sheet 141 from the sheet body 141a (i.e., the thickness of the protrusion 141b) is set to be substantially the same as the thickness of the planar main body portion 40a of the cover member 140. Therefore, in a completed state of the imaging apparatus 110, the plurality of elongated bottomed grooves 141c and the plurality of light shield walls 141d correspond in configuration to the plurality of slits 40i (which includes the bottoms thereof that are defined by portions of the front surface of the cover sheet 41) and the plurality of light shield walls 40j of the previous embodiment of the imaging apparatus 10, which makes it possible to obtain the effect of reducing internal reflection caused by the cover member 140 while maintaining compactness of the imaging apparatus 110 in the forward and rearward directions with no increase in thickness of the cover member 140. In addition, the light shield structure of the imaging apparatus 110 has a simple structure that includes the cover member 140, in which the through-hole 140i is formed, and the cover sheet 141 that is mounted to the cover member 140, thus being superior in productivity and production cost.

Although the present invention has been described based on the above illustrated embodiments, the present invention is not limited solely thereto; various modifications to the above illustrated embodiment are possible without departing from the scope of the invention. For instance, although the imaging optical system of each of the above described embodiments of the imaging apparatuses 10 and 110 is provided with a bending optical system including reflector elements such as the first prism L11 and the second prism L12, the present invention can also be applied to an imaging apparatus having an imaging optical system that is not provided with a bending optical system.

Although a combination of the housing 15 and the cover member 40 or 140 forms an optical path forming member in each of the above illustrated embodiments of the imaging apparatuses 10 and 110, the present invention can also be applied to an imaging apparatus which includes an optical path forming member, wherein a portion of this optical path forming member which corresponds to the cover member 40 or 140 is integrally formed with the housing 15.

The present invention is especially suitable for the case where the optical path forming member, in which at least one through-hole (such as the plurality of slits 40i or the through-hole 140i) is formed, is made of metal such as the cover member 40 or 140; however, the material of the optical path forming member is not limited to metal and can be a synthetic resin or the like.

Although the plurality of slits 40i or the through-hole 140i are formed in the cover member 40 or 140 which is positioned on the rear side of the imaging apparatus 10 or 110 (the rear side being closest to the second optical axis O2 among the exterior walls of the optical path forming member) in each of the above illustrated embodiments, an alternative position can be selected for forming of the through-portion(s) such as the plurality of slits 40i or the through-hole 140i with respect to the circumferential direction about the optical axis of the imaging optical system. For instance, in each of the imaging apparatuses 10 and 110, the distance from the second optical axis O2 to the front wall of the housing 15 is small (compared with the distance of either the upper wall or the lower wall of the housing 15 from the second optical axis O2), though not so small as that from the second optical axis O2 to the cover member 40 or 140 that is positioned on the rear side of the imaging apparatus 10 or 110, and accordingly, it is also effective to provide a light shield structure, similar to the cover member 40 or 140 that is positioned on the rear side of the imaging apparatus 10 or 110, on the front side of the housing 15. Additionally, unlike each of the above illustrated embodiments of the imaging apparatuses 10 and 110, in a type of imaging apparatus in which the position of the second optical axis O2 is set to be a little closer to the front (i.e., to the front wall of the housing 15) than the planar main body portion 40a of the cover member 40 or 140, it is also possible to provide a light shield structure, which includes at least one through-hole such as the plurality of slits 40i or the through-hole 140i, only on the front wall of the housing 15 without providing a light shield structure (composed of the plurality of slits 40i and the plurality of light shield walls 40j, or the through-hole 140i, the plurality of elongated bottomed grooves 141c and the plurality of light shield walls 141d) which includes at least one through-hole on the cover member 40 or 140 on the rear wall of the housing.

The plurality of slits 40i, which are formed in the first embodiment of the imaging apparatus 10, are mutually identical in width and arranged at substantially regular intervals, the plurality of light shield walls 40j, which are formed in the first embodiment of the imaging apparatus 10, are mutually identical in width and arranged at substantially regular intervals, the plurality of elongated bottomed grooves 141c, which are formed in the second embodiment of the imaging apparatus 110, are mutually identical in width and arranged at substantially regular intervals, and the plurality of light shield walls 141d, which are formed in the second embodiment of the imaging apparatus 110, are mutually identical in width and arranged at substantially regular intervals in the above illustrated embodiments; however, it is possible for the slits 40i, the walls 40j, the elongated bottomed grooves 141c and the plurality of light shield walls 141d to be formed mutually different in width and/or arranged at irregular intervals.

Although the plurality of slits 40i and the plurality of light shield walls 40j, which are formed in the imaging apparatus 10, and the plurality of elongated bottomed grooves 141c and the plurality of light shield walls 141d, which are formed on in the imaging apparatus 110, all extend in a direction substantially orthogonal to an optical axis (the second optical axis O2) (i.e., in the vertical direction) in the above illustrated embodiments, a certain degree of light shield effect on reduction of internal reflection can be achieved even if the extending directions of all the slits, walls and grooves are made to be inclined to some degree (even if these extending directions are given a component of tilt in the leftward and rightward directions of the imaging apparatus 10 or 110), and the present invention does not exclude such a modified embodiment.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging apparatus comprising:
an optical path forming member which includes at least one exterior wall surrounding an imaging optical system and defines an optical path inside said exterior wall;
a through-portion which extends through said exterior wall of said optical path forming member;
a lid member which covers said through-portion from the outside of said optical path forming member; and
a plurality of light shield walls provided on one of said optical path forming member and said lid member, wherein said plurality of light shield walls are intermittently arranged in a direction along an optical axis of said imaging optical system so that said through-portion includes a plurality of internal spaces which are respectively positioned between said light shield walls.

2. The imaging apparatus according to claim 1, wherein said plurality of internal spaces comprises a plurality of slits provided in said exterior wall of said optical path forming member, and
wherein said plurality of light shield walls are portions of said exterior wall, said plurality of light shield walls being alternately positioned between said plurality of slits in said direction along said optical axis of said imaging optical system.

3. The imaging apparatus according to claim 1, wherein said lid member comprises a protrusion which is inserted into said through-portion, and
wherein said plurality of light shield walls are provided on said protrusion of said lid member.

4. The imaging apparatus according to claim 1, wherein said imaging optical system comprises at least one movable lens group which is movable along said optical axis, and
wherein a range of formation of said through-portion and said plurality of light shield walls in said direction along said optical axis includes at least a part of a moving range of said movable lens group, said part of said moving range ranging from a center of said moving range to a limit of travel of said movable lens group on the image side of said moving range.

5. The imaging apparatus according to claim 1, wherein said through-portion and said plurality of light shield walls are provided on at least a portion of said exterior wall, a distance from said optical axis to said portion of said exterior wall being the shortest compared to distances, in a plane orthogonal to said optical axis, from said optical axis to a remaining portion of said exterior wall.

6. The imaging apparatus according to claim 1, wherein said optical path forming member is formed from a combination of a box-shaped body and a cover,
wherein one side of sides of said box-shaped body that surround said optical path is open,
wherein said cover closes said opening of said box-shaped body, and
wherein said through-portion is provided in said cover.

7. The imaging apparatus according to claim 1, wherein said lid member comprises a thin sheet which is smaller in thickness than said exterior wall of said optical path forming member.

8. The imaging apparatus according to claim 1, wherein said imaging optical system comprises a bending optical system, including a reflector element which reflects light rays traveling from an object toward said image plane, and
wherein said through-portion and said plurality of light shield walls are provided at positions which are closer to said image side than said reflector element and surround said optical path.

9. An imaging apparatus comprising:
an optical path forming member which includes at least one exterior wall surrounding an imaging optical system and defines an optical path inside said exterior wall;
a plurality of slits which extend through said exterior wall of said optical path forming member and a plurality of light shield walls which are formed as portions of said exterior wall, said plurality of slits and said plurality of light shield walls being provided in said optical path forming member and alternately arranged in a direction along an optical axis of said imaging optical system; and
a cover sheet which is mounted onto an outer surface of said exterior wall of said optical path forming member to cover said plurality of slits.

10. The imaging apparatus according to claim 9, wherein said optical path forming member is formed from a combination of a box-shaped body and a cover,
wherein one side of sides of said box-shaped body that surround said optical path is open,
wherein said cover closes said opening of said box-shaped body, and
wherein said plurality of slits are provided in said cover.

11. An imaging apparatus comprising:
an optical path forming member which includes at least one exterior wall surrounding an imaging optical system and defines an optical path inside said exterior wall;
a through-hole which extends through said exterior wall of said optical path forming member;
a cover sheet which is mounted onto an outer surface of said exterior wall of said optical path forming member to cover said through-hole, said cover sheet including a protrusion which is inserted into said through-hole; and
a plurality of grooves and a plurality of light shield walls which are provided in said protrusion of said cover sheet and alternately arranged in a direction along an optical axis of said imaging optical system.

12. The imaging apparatus according to claim 11, wherein said optical path forming member is formed from a combination of a box-shaped body and a cover,
wherein one side of sides of said box-shaped body that surround said optical path is open,
wherein said cover closes said opening of said box-shaped body, and
wherein said through-hole is provided in said cover.
